(19) United States
(12) Patent Application Publication
(10) Pub. No.: US 2021/0199157 A1
(43) Pub. Date: Jul. 1, 2021

(54) BEARING SUPPORT STRUCTURE

(71) Applicant: JTEKT CORPORATION, Osaka-shi, Osaka (JP)

(72) Inventor: Kensuke KIMURA, Yokohama-shi (JP)

(73) Assignee: JTEKT CORPORATION, Osaka-shi, Osaka (JP)

(21) Appl. No.: 16/978,151

(22) PCT Filed: Jan. 25, 2019
(86) PCT No.: PCT/JP2019/002434

§ 371 Date: Sep. 3, 2020

(30) Foreign Application Priority Data
Mar. 20, 2018 (JP) 2018-053371

(51) Int. Cl. F16C 33/58; F16C 9/02; F16C 33/60; F16C 19/46

(52) U.S. Cl. CPC F16C 33/585; F16C 9/02; F16C 2226/70; F16C 19/463; F16C 33/60

(57) ABSTRACT

A bearing support structure wherein a shaft member that rotates about a central axis is rotatably supported by a rolling bearing split into two portions in a peripheral direction, wherein the shaft member has a fitting portion into which the rolling bearing is externally fitted, the fitting portion has a non-round shape in a direction orthogonal to the central axis, and the rolling bearing includes an inner ring that is split into two portions in a peripheral direction and is externally fitted to the fitting portion and has an inner raceway surface on an outer periphery, an outer ring that is split into two portions in a peripheral direction and is fixed radially outward of the inner ring, and that has an outer raceway surface coaxial with the inner raceway surface on an inner periphery, and a plurality of rolling elements rotatably disposed between the inner and outer raceway surfaces.

### TECHNICAL FIELD

One aspect of the present invention relates to a rolling bearing in which an inner ring is split in a peripheral direction.

### BACKGROUND ART

Conventionally, a crank journal of an internal combustion engine used for vehicles such as automobiles or outboard motors has a crank journal supported by a slide bearing. However, since the sliding bearing needs to supply a large amount of lubricating oil and requires a dedicated oiling device, the weight of the vehicle increases. Therefore, in recent years, efforts have been made to reduce the weight of a vehicle by eliminating the need for the oiling device by changing the sliding bearing to a rolling bearing.

The crank journal is in a position sandwiched by the crank arms in the axial direction. Therefore, an annular rolling bearing cannot be mounted as it is. Therefore, split type rolling bearings that are split into two portions in the peripheral direction are used as the rolling bearings that rotatably support the crankshaft (see Patent Literatures 1 and 2). The split semicircular rolling bearings are mounted on both sides in the radial direction with the crank journals interposed therebetween, and are integrally fixed inside the housing.

The rolling bearing described in Patent Literature 1 or Patent Literature 2 does not include an inner ring, and the rolling element rolls on the outer peripheral surface of the crank journal as a raceway surface. Usually, in order to ensure the rolling life, the raceway surface of the rolling bearing needs to have a hardness of approximately 60 HRC or more. However, since the crankshaft manufactured by hot forging has a relatively low carbon content of about 0.3% to 0.5%, and it is difficult to increase the surface hardness of the crank journal.

Therefore, it has been studied to ensure the rolling life by incorporating an inner ring split in two in the peripheral direction on the outer periphery of the crank journal.

### PRIOR ART LITERATURE

### Patent Literature

[Patent Literature 1] JP-A-2007-139153
[Patent Literature 2] JP-A-2012-225426

### SUMMARY OF INVENTION

### Technical Problem

In a rolling bearing split into two portions in the peripheral direction, a step or a clearance may occur on the raceway surface at an abutting portion of the inner and outer rings. Therefore, when the rolling element passes through the abutting portion, abnormal noise may occur, and the rolling life may decrease due to the impact. Therefore, when the split type rolling bearing is assembled, it is necessary to assemble such that a direction of the abutting portion of the inner and outer rings and a direction of the load acting on the rolling bearing do not overlap.

However, when the inner ring is split in the peripheral direction, even if the bore diameter of the inner ring is smaller than the outside diameter of the shaft, only a clearance is generated between the split inner rings, and the inner ring cannot be incorporated in the outer periphery of the shaft with an interference fit. Therefore, the inner ring may rotate during use, and the direction of the abutting portion of the inner and outer rings may overlap with the direction of the load acting on the rolling bearing.

As shown in FIG. 6, as a means for preventing the inner ring 51 from rotating about the crank journal 52, a method of incorporating a pin 53 passing through the inner ring 51 and the crank journal 52 in the radial direction or incorporating a key (not shown) on a fitting surface between the inner ring 51 and the crank journal 52 can be considered. However, in the crankshaft, it is difficult to make the key groove and the pin hole 54 large in order to ensure the strength. Further, when a small key or pin 53 is used, the contact surface pressure of the key groove or the pin hole 54 becomes high, and wear and deformation may increase. Further, in the internal combustion engine, there is a strong demand for weight reduction and the inner ring 51 has a small radial plate thickness. Therefore, the pin 53 or the key may protrude to the outer periphery of the inner ring 51. In this case, there are problems that the raceway surface 56 of the inner ring 51 shrinks, and the rolling life is reduced.

In view of the above situation, an aspect of the present invention is directed to preventing rotation of an inner ring with respect to a rotation shaft without using a rotation stopper such as a pin or a key in a bearing support structure that supports the rotation shaft such as a crankshaft by a rolling bearing in which an inner ring is split in a peripheral direction.

### Solution to Problem

In one aspect of the present invention, in a bearing support structure in which a shaft member rotating about a central axis is rotatably supported by a rolling bearing split into two portions in a peripheral direction, the shaft member includes a fitting portion into which the rolling bearing is externally fitted. The fitting portion includes a non-round shape in a direction orthogonal to the central axis. The rolling bearing includes an inner ring that is split into two portions in a peripheral direction and is externally fitted to the fitting portion and that has an inner raceway surface on an outer periphery, an outer ring that is split into two portions in a peripheral direction and is fixed radially outward of the inner ring, and that has an outer raceway surface coaxial with the inner raceway surface on an inner periphery, and a plurality of rolling elements rotatably disposed between the inner raceway surface and the outer raceway surface. An inner periphery of the inner ring has a shape corresponding to an outer periphery of the fitting portion, a section in the direction orthogonal to the central axis is a non-round shape, and radial displacement of the inner ring is restricted, so that rotation of the inner ring with respect to the shaft member is prevented.

### Advantageous Effects of Invention

According to the aspect of the present invention, the rotation of an inner ring with respect to the rotation shaft without using a rotation stopper such as a pin or a key in a bearing support structure that supports the rotation shaft such as a crankshaft can be prevented by a rolling bearing in which the inner ring is split in the peripheral direction. Thus, since the assembled state of the inner ring can be maintained such that the direction of the abutting portion of the inner ring and the direction of the load acting on the rolling bearing do not overlap, occurrence of abnormal noise over a long period of time can be prevented, and a good rolling life can be ensured.

### BRIEF DESCRIPTION OF DRAWINGS

FIG. 1 is an axial sectional view of a crankshaft into which a rolling bearing of a first embodiment is incorporated.

FIG. 2 is an enlarged axial sectional view of a portion of a crank journal.

FIG. 3 is a sectional view of the crank journal in a direction orthogonal to the central axis.

FIG. 4 is an explanatory view illustrating an effect of preventing rotation of the inner ring.

FIG. 5(a) is an axial sectional view of a portion of the crank journal according to another embodiment, and FIG. 5(b) is a sectional view in a direction orthogonal to the central axis.

FIG. 6 is an axial sectional view showing a conventional rotation stopper.

### DESCRIPTION OF EMBODIMENTS

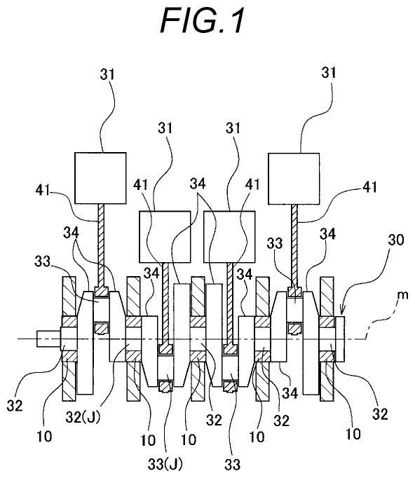

Embodiments of a rolling bearing according to the present invention will be described in detail with reference to the drawings. FIG. 1 is an axial sectional view of a crankshaft 30 (shaft member) in which a rolling bearing 10 according to a first embodiment of the present invention is incorporated. The crankshaft 30 is a component that is incorporated in an internal combustion engine such as an outboard motor or an automobile and converts reciprocating motion of a piston 31 into rotational motion. In the following description, the direction of the central axis m of the crankshaft 30 is referred to as an axial direction, the direction orthogonal to the central axis m is referred to as a radial direction, and the direction about the central axis m is referred to as a peripheral direction.

The crankshaft 30 is manufactured by hot forging a carbon steel or alloy steel having a carbon content of about 0.3% to 0.5%, and is integrally formed with a plurality of crank journals 32 (fitting portions), a plurality of crank pins 33, and a plurality of crank arms 34 connecting each crank journal 32 and each crank pin 33. In the crankshaft 30 in FIG. 1, the crank journals 32 are formed at five positions in the axial direction, and the crank pins 33 are formed at four positions in the axial direction.

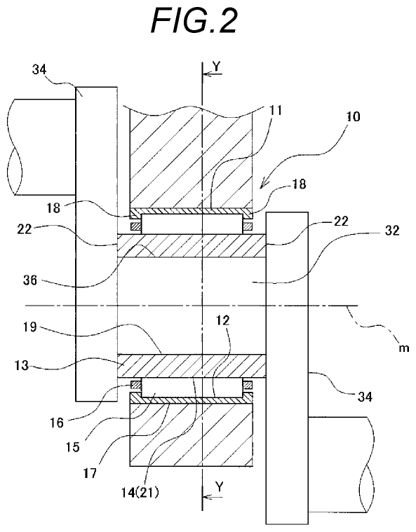

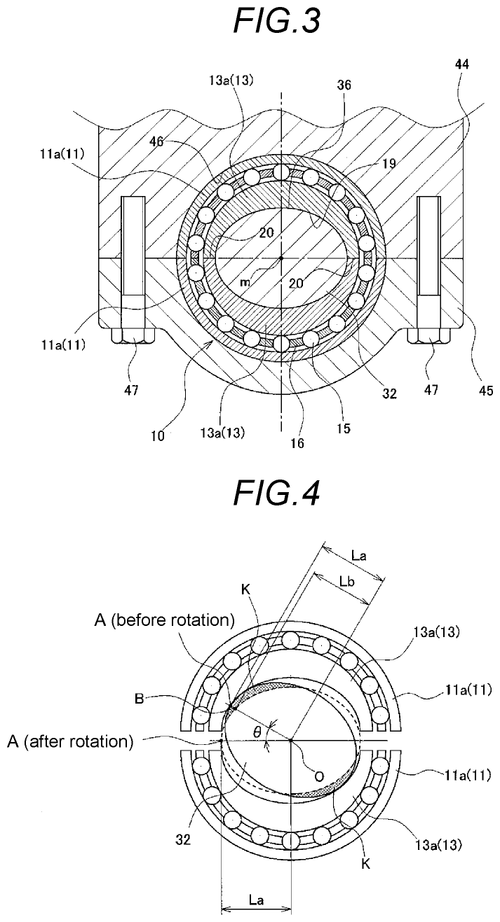

The configuration of the crank journal 32 will be described with reference to FIGS. 2 and 3. Since the configurations of the crank journals 32 are the same, the crank journal 32 denoted by J in FIG. 1 will be described as an example.

FIG. 2 is an axial sectional view of the crank journal 32 in which the rolling bearing 10 is incorporated in the outer periphery thereof. FIG. 3 is a sectional view taken along the line Y-Y in a direction orthogonal to the central axis m in FIG. 2.

Each of the crank journals 32 has a columnar shape and is formed coaxially with each other along the central axis m. The cross section orthogonal to the central axis m is uniform in the axial direction and has an elliptical shape. In the first embodiment, the outer peripheral surface 36 of the crank journal 32 is subjected to a grinding process after the hardness is increased by induction hardening or the like.

The rolling bearings 10 are externally fitted to the outer periphery of the crank journal 32, respectively, and the crankshaft 30 rotates about the crank journals 32.

Referring to FIG. 1 again. Each crank pin 33 has a circular column shape and is provided parallel to the central axis m at a position eccentric in the radial direction from the crank journal 32. The outer peripheral surface of the crank pin 33 is subjected to a grinding process after the hardness is increased by induction hardening or the like. Each crank pin 33 is connected to a piston 31 via a connecting rod 41.

In the internal combustion engine, by periodically explosively combusting fuel such as gasoline, the pistons 31 are displaced in a vertical direction in FIG. 1, and the crank pins 33 rotate about the crank journals 32. Since the fuel is ignited when the pistons 31 are displaced upward, the load applied to the crank journals 32 becomes the largest immediately after the ignition of the fuel, that is, when the crank pins 33 rotate by a predetermined angle β in the rotation direction of the crankshaft 30 with reference to positions above the crank journals 32. The angle β is approximately 30° (20°β<40°).

Next, a configuration of the rolling bearing 10 will be described with reference to FIG. 2. The rolling bearing 10 is a needle roller bearing, and includes an outer ring 11, an inner ring 13, a plurality of needle rollers 15 as rolling elements, and a cage 16. The outer ring 11, the inner ring 13, and the cage 16 are split in the peripheral direction.

The outer ring 11 is made of high carbon steel such as bearing steel. When the outer ring 11 split into two portions in the peripheral direction (hereinafter referred to as “outer ring piece 11a”) is assembled, an outer peripheral surface 17 is formed of a single cylindrical surface. An outer raceway surface 12 is formed at the center of the inner periphery in the axial direction over the entire periphery, and small-diameter flanges 18, 18 are formed on both outer sides of the outer raceway surface 12 in the axial direction. The outer raceway surface 12 has a cylindrical shape coaxial with the outer peripheral surface 17, and is a surface on which the needle rollers 15 roll.

The flanges 18, 18 protrude radially inward from the outer raceway surface 12, and the needle rollers 15 are guided by the flanges 18, 18 to roll in the peripheral direction. The needle rollers 15 may be guided by the crank arms 34 to roll in the peripheral direction. In this case, it is not necessary to provide the flanges 18, 18 on the outer ring 11. The outer peripheral surface 17 and the outer raceway surface 12 are finished by a grinding process after the outer ring 11 is quenched.

The inner ring 13 is made of high carbon steel such as bearing steel. When the inner ring 13 split into two portions in the peripheral direction (hereinafter referred to as “inner ring piece 13a ”) is assembled, the inner ring has a substantially cylindrical shape as a whole.

An inner raceway surface 14 is formed at the center of the outer periphery of the inner ring 13 in the axial direction over the entire periphery. The inner raceway surface 14 is a surface on which the needle rollers 15 roll, and the inner raceway surface 14 when the inner ring pieces 13a, 13a are assembled is formed by a single cylindrical surface.

The inner periphery of the inner ring 13 has a shape corresponding to the outer periphery of the crank journal 32. That is, the inner peripheral surface 19 has an elliptical shape whose cross section in a direction orthogonal to the central axis m is the same as the cross section in a direction orthogonal to the central axis m of the crank journal 32.

The inner raceway surface 14 and the inner peripheral surface 19 are finished by a grinding process after the inner ring 13 is quenched. In the rolling bearing 10, the outer ring 11 is disposed coaxially outward of the inner ring 13 in the radial direction.

In the first embodiment, the inner ring 13 is split into two portions by a split plane 20 that includes a central axis m and extends in the radial direction at a position where the radial thickness is minimum. The direction of the split plane 20 is not limited to the first embodiment. For example, the split plane may include a central axis m and be orthogonal to the split plane 20 of the first embodiment (that is, a direction in which the radial thickness is the maximum).

Both axial end portions of the inner peripheral surface 19 and the outer peripheral surface 21 of the inner ring 13 are connected to each other by end surfaces 22, 22 which are formed of planes orthogonal to the central axis m. The axial dimension between the end surfaces 22, 22 is slightly smaller than the axial inner width of the crank arms 34, 34 on both axial sides of the crank journal 32.

The needle roller 15 has a circular columnar shape that is relatively long in the axial direction with respect to the diameter, and is made of a steel material such as bearing steel. In the rolling bearing 10, a plurality of needle rollers 15 are disposed between the outer ring 11 and the inner ring 13 with the axes thereof oriented in the same direction as the central axis m.

The cage 16 has a thin cylindrical shape, and is made of a resin material such as polyamide or a thin carbon steel plate. The cage 16 includes a plurality of holes (not shown) penetrating in the radial direction called “pockets”. The pockets are provided at equal intervals in the peripheral direction, and the needle rollers 15 are disposed at equal intervals in the peripheral direction by being accommodated in the respective pockets.

In addition to the first embodiment, the rolling bearing 10 may be a so-called full-roller type rolling bearing in which the cage 16 is not provided and the needle rollers 15 are disposed close to each other in the peripheral direction.

Next, the assembled state of the rolling bearing 10 will be described with reference to FIG. 3.

The two-split rolling bearing 10 is assembled to the crank journal 32 from both sides in the radial direction, and is integrally assembled inside the housings 44, 45.

When the rolling bearing 10 is assembled, first, the two-split inner ring pieces 13a, 13a are attached. Each of the inner ring pieces 13a, 13a is assembled from the radially outer side thereof such that the direction of the elliptical shape of the inner peripheral surface 19 coincides with the direction of the elliptical shape of the outer peripheral surface 36 of the crank journal 32. Next, the outer ring pieces 11a, 11 a assembled with the needle rollers 15 and the cage 16 are assembled.

The split rolling bearing 10 assembled to the outer periphery of the crank journal 32 is fixed to an engine block by being sandwiched in the radial direction by the upper housing 44 integrally formed with the engine block (not shown) and the lower housing 45 provided on a side of an oil pan (not shown).

The upper housing 44 and the lower housing 45 each have a semicircular inner peripheral surface 46, and when assembled as shown in FIG. 3, the inner peripheral surface 46 thereof is a single cylindrical surface having a diameter slightly smaller than the outside diameter of the outer ring 11 of the rolling bearing 10. By fastening the lower housing 45 and the upper housing 44 with bolts 47, 47, the outer ring 11 is fixed to the inner periphery of each of the housings 44, 45 in an interference fit state.

Thus, the crankshaft 30 is attached to the engine block via the rolling bearings 10, and can rotate about the crank journals 32 as a rotation axis. When the crankshaft 30 rotates, the needle rollers 15 revolve about the central axis m while rolling between the outer raceway surface 12 and the inner raceway surface 14.

Next, the operation and effect of preventing the rotation of the inner ring 13 by the bearing support structure of the first embodiment will be described.

FIG. 4 is an explanatory view for illustrating the operation and effect of the first embodiment, and schematically shows a state in which the inner ring 13 is rotated about the crank journal 32. In order to avoid complication of the drawing, in FIG. 4, it shows the situation that the inner ring 13 and the crank journal 32 are relatively rotated by fixing the inner ring 13 in the peripheral direction and changing the phase of the crank journal 32 in the peripheral direction.

In FIG. 4, the crank journal 32 before the inner ring 13 and the crank journal 32 are relatively displaced (hereinafter referred to as “before rotation”), that is, in the state shown in FIG. 3, is shown by a broken line, and the crank journal 32 when displaced by an angle θ in the peripheral direction with respect to the inner ring 13 (hereinafter referred to as “after rotation”) is shown by a solid line. Before rotation, as shown in FIG. 3, the outer periphery of the crank journal 32 and the inner periphery of the inner ring 13 are in contact with each other over the entire periphery.

In FIG. 4, it is shown a situation that the outer ring 11 is not fixed by a housing or the like, and the inner ring 13 and the crank journal 32 rotate relative to each other so that the split rolling bearings 10 are displaced from each other in the radial direction.

The crank journal 32 has an elliptical sectional shape in a direction orthogonal to the central axis m and has a non-round shape. Thus, the dimension L from the central axis m to the outer peripheral surface 36 of the crank journal 32 is different from each other according to the peripheral direction. When the center of the ellipse is set to O, the point on the outer peripheral surface 36 in the major axis direction is set to A, and the point on the outer peripheral surface 36 inclined in the peripheral direction by an angle θ is set to B, the distance Lb between the center O and the point B is smaller than the distance La between the center O and the point A.

Therefore, if it is assumed that the crank journal 32 is rotated relative to the inner ring 13 by the angle θ, the point A on the outer peripheral surface 36 after rotation is displaced radially outward from the point B on the outer peripheral surface 36 before rotation. That is, in the region K indicated by cross-hatching in FIG. 4, the outer periphery of the crank journal 32 after rotation is located radially outward of the outer periphery of the crank journal 32 before rotation.

Therefore, as shown in FIG. 4, when the outer ring 11 is not fixed to the housing or the like, the split rolling bearings 10 are displaced in a direction away from each other in the radial direction (in the vertical direction in FIG. 4) by being biased by the crank journals 32. At this time, in the vertical direction of FIG. 4, the radial dimension of the inner peripheral surface 19 of the inner ring 13 increases, and the radial dimension of the outer peripheral surface 17 of the outer ring 11 increases.

However, in the first embodiment, the outer ring 11 is fixed on the inner periphery of the housings 44, 45, and is not displaced in the radial direction. In the rolling bearing 10, the radial clearance is extremely small, and the difference between the inscribed diameter of the needle roller 15 and the diameter of the inner raceway surface 14 is about several tens of The dimensional difference between the diameters corresponds to the radial clearance of the rolling bearing 10. Therefore, when the inner ring 13 and the crank journal 32 are relatively displaced in the peripheral direction, the inner raceway surface 14 and the outer raceway surface 12 immediately come into contact with each other via the needle rollers 15, and the radial displacement of the inner ring 13 is restricted. Therefore, since the radial dimension of the inner peripheral surface 19 of the inner ring 13 hardly changes, the crank journal 32 cannot be relatively displaced in the peripheral direction with respect to the inner ring 13. Thus, the bearing support structure of the first embodiment can prevent the inner ring 13 from rotating in the peripheral direction with respect to the crank journal 32.

In the first embodiment, the outer peripheral surface 36 of the crank journal 32 and the inner peripheral surface 19 of the inner ring 13 have shapes corresponding to each other, and the sectional shapes in the direction orthogonal to the central axis m are the same elliptical shape. Therefore, the radii of curvature about the center axis m at the contact position between the outer peripheral surface 36 and the inner peripheral surface 19 are equal to each other. Therefore, since the inner ring 13 and the crank journal 32 are in contact with each other in the peripheral direction, the contact surface pressure can be reduced. Therefore, wear of the outer peripheral surface 36 of the crank journal 32 and the inner peripheral surface 19 of the inner ring 13 can be suppressed.

Further, in the first embodiment, since the rotation of the inner ring 13 can be prevented only by fitting the outer peripheral surface 36 of the crank journal 32 and the inner peripheral surface 19 of the inner ring 13 to each other, the axial length of the inner ring 13 is not limited. Further, since the keys and the pins are not used, these do not protrude to the outer periphery of the inner ring 13. Therefore, in the bearing support structure of the first embodiment, since the axial length of the inner raceway surface 14 is not limited, the load capacity of the rolling bearing 10 does not decrease, and a good rolling life can be ensured. Furthermore, since it is not necessary to provide a key groove, a pin hole or the like, the strength of the crank journal 32 can be ensured.

Further, since the keys or the pins are not used, the number of components can be reduced, and it is not necessary to provide a key groove, a pin hole, or the like in the crank journal 32, thus, the number of machining steps can be reduced, and the crankshaft 30 can be manufactured at low cost.

As described above, in the bearing support structure of the first embodiment, even when the split type rolling bearing 10 in which the inner ring 13 is split in the peripheral direction is used, the rotation of the inner ring 13 can be prevented without using a rotation stopper such as a pin or a key. Therefore, by assembling such that the direction of the abutting portion of the inner ring 13 and the direction of the load acting on the rolling bearing 10 do not overlap in advance, the assembled state can be maintained, the occurrence of abnormal noise can be prevented over a long period of time, and the rolling life can be ensured.

In the first embodiment, the crank journal 32 has an elliptical section shape in a direction orthogonal to the central axis m, but is not limited thereto. Although not shown, for example, even when the section in the direction orthogonal to the central axis m is a polygonal shape such as a square, the same operation and effect can be obtained.

In the first embodiment, the case where the crank journal 32 has a columnar shape having a uniform section in the axial direction has been described. However, the present invention is not limited thereto, and a part of the crank journal 32 in the axial direction may have an elliptical section shape in a direction orthogonal to the central axis m.

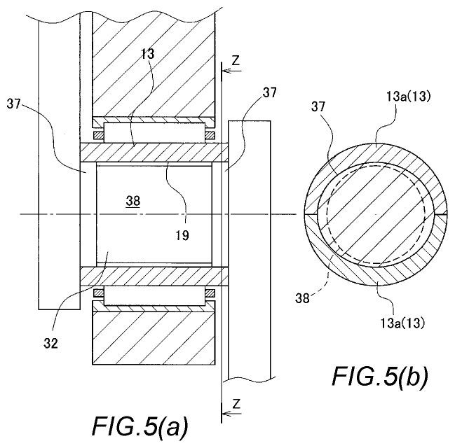

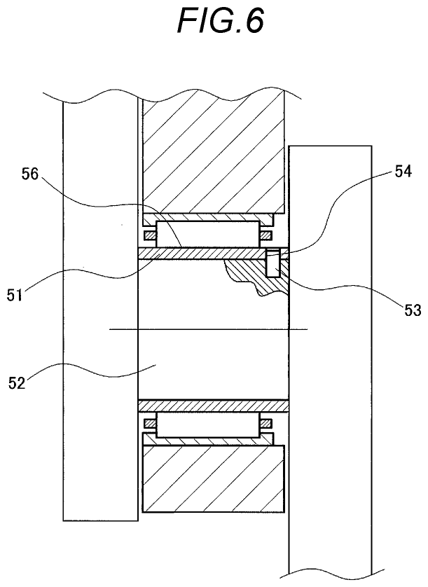

FIG. 5 shows an embodiment in which rotation stopper portions 37, 37 having an elliptical section shape in a direction orthogonal to the central axis m are formed in a part of the crank journal 32 in the axial direction. FIG. 5(a) is an axial sectional view, and FIG. 5(b) is a sectional view taken along the line Z-Z in FIG. 5(a). In the present embodiment, the rotation stopper portions 37, 37 are formed coaxially with each other at both axial end portions of the crank journal 32, and a cylindrical portion 38 having a round section is provided at the center in the axial direction. The inner peripheral surface 19 of the inner ring 13 has a shape corresponding to the outer periphery of the rotation stopper portions 37, 37, and has an elliptical shape similar to that of the rotation stopper portions 37, 37. The inner ring 13 has a uniform section in the axial direction, and the inner peripheral surface 19 thereof is not in contact with the cylindrical portion 38.

Also in the present embodiment, when the inner ring 13 is split into two portions in the peripheral direction, and the crank journal 32 rotates in the peripheral direction, the inner ring 13 is biased radially outward (in the vertical direction in FIG. 5) by the rotation stopper portions 37, 37 on both sides in the axial direction. As in the first embodiment, the inner ring 13 is restricted from moving in the radial direction, the rotation of the inner ring 13 along the outer periphery of the crank journal 32 can be prevented.

The embodiments of the present invention have been described above. However, the embodiments described above are merely examples for implementing the present invention. Therefore, the present invention is not limited to the embodiments described above, and can be implemented by appropriately modifying the embodiments described above without departing from the scope of the invention.

This application is based on a Japanese Patent Application (Japanese Patent Application No. 2018-053371) filed on Mar. 20, 2018, the contents of which are incorporated herein by reference.

### REFERENCE SIGN LIST

10 Rolling bearing
11 Outer ring
11a Outer ring piece
12 Outer raceway surface
13 Inner ring
13a Inner ring piece
14 Inner raceway surface
15 Needle roller
16 Cage
17 Outer peripheral surface
18 Flange
19 Inner peripheral surface
20 Split plane
30 Crankshaft
31 Piston
32 Crank journal
33 Crank pin
34 Crank arm
36 Outer peripheral surface (Crank journal)
51 Inner ring
52 Crank journal
53 Pin
54 Pin hole

1. A bearing support structure in which a shaft member rotating about a central axis is rotatably supported by a rolling bearing split into two portions in a peripheral direction,
wherein the shaft member includes a fitting portion into which the rolling bearing is externally fitted,
wherein the fitting portion includes a non-round shape in a direction orthogonal to the central axis,
wherein the rolling bearing includes:
an inner ring that is split into two portions in a peripheral direction and is externally fitted to the fitting portion and that has an inner raceway surface on an outer periphery;
an outer ring that is split into two portions in a peripheral direction and is fixed radially outward of the inner ring, and that has an outer raceway surface coaxial with the inner raceway surface on an inner periphery; and
a plurality of rolling elements rotatably disposed between the inner raceway surface and the outer raceway surface, and
wherein an inner periphery of the inner ring has a shape corresponding to an outer periphery of the fitting portion, a section in the direction orthogonal to the central axis is a non-round shape, and radial displacement of the inner ring is restricted, so that rotation of the inner ring with respect to the shaft member is prevented.

2. The bearing support structure according to claim 1,
wherein the non-round shape is an elliptical shape.
